(19) United States
(12) Patent Application Publication
(10) Pub. No.: US 2026/0138488 A1
(43) Pub. Date: May 21, 2026

(54) ADAPTER SYSTEM, MOTOR VEHICLE COMPRISING AN ADAPTER, AND MEASURING METHOD FOR DISPENSING OR RECEIVING ELECTRIC ENERGY FOR A MOTOR VEHICLE

(71) Applicant: WEBASTO SE, Stockdorf (DE)

(72) Inventor: Christian Jetzinger, Monrovia, CA (US)

(21) Appl. No.: 18/870,351

(22) PCT Filed: May 30, 2023
(86) PCT No.: PCT/EP2023/064358

§ 371 Date: Jan. 28, 2025

(30) Foreign Application Priority Data
May 30, 2022 (DE) 10 2022 113 541.1

(51) Int. Cl. B60L 53/66; B60L 53/16; B60L 53/18; B60L 53/65; B60L 53/68; B60L 55/00

(52) U.S. Cl. CPC B60L 53/665; B60L 53/16; B60L 53/18; B60L 53/65; B60L 53/68; B60L 55/00; B60L 2270/38

(57) ABSTRACT

The present invention concerns an adapter system for a motor vehicle which comprises at least one adapter of the adapter system and a measuring method for a motor vehicle in which the electrical energy transmitted to the motor vehicle is documented in a server unit for a price statement via the motor vehicle independently of the charging device.

### CROSS-REFERENCE TO RELATED APPLICATIONS

This application is a 35 U.S.C. § 371 National Stage Entry of International Application No. PCT/EP 2023/064358 filed May 30, 2023, which claims the priority benefit of German Patent Application Serial Number DE 10 2022 113 541.1 filed May 30, 2022, all of which are incorporated herein by reference in their entirety for all purposes.

### TECHNICAL FIELD

The present invention relates to an adapter system, a motor vehicle comprising an adapter and a measuring method for receiving or supplying electrical energy for a motor vehicle.

### CURRENT STATE OF THE ART

Charging devices and charging cables are often not equipped with a power meter or are equipped with an inadequate power meter, so that the amount of electrical energy that is charged into a motor vehicle cannot be measured or cannot be measured accurately enough to be used for billing purposes. For example, company car drivers cannot charge at all charging stations because the electrical energy supplied by the respective charging station to the vehicle cannot be measured everywhere, and thus there is no proof for a price statement of the charged electrical energy, which is mandatory for example under German law for company cars. For example, it is difficult for users of company cars that charge at home using a domestic power connection or on the road at a third-party charging station to provide an exact price statement for the electrical energy charged for the company car. Furthermore, an exact price statement and/or compensation is required for a user of an electrically powered vehicle when the battery of the electrically powered vehicle is used as a storage device for electrical energy in the context of operating an electricity grid. In such cases, the electrical energy must also be measured precisely, i.e. the energy that was supplied from the grid to the vehicle for storage and the energy that was supplied from the vehicle to the grid.

A charging system for a motor vehicle is known from EP 3 017 994 A2, in which a control unit integrated in a charging cable is designed as an In-Cable Control Box (ICCB) and measures an electrical energy used for charging, as well as a state of charge of the battery in the motor vehicle. The control unit can send the measured electrical energy together with a location and the state of charge of the battery in the motor vehicle to a server unit for controlling the charging current and for billing the charged energy.

A charging system for a motor vehicle is known from EP 3 266 646 A1, in which an identity of a motor vehicle charging at a charging device is verified by data synchronization both by means of a server of the charging device and by means of a server of a network operator. When authentication has been successful, an amount of electrical energy charged at the charging device is measured and billed via the servers of the network operator and the charging device. For this purpose, an adapter in the charging cable of the charging device communicates wirelessly with the server of the charging device via an interface.

A control unit with a first and second communication unit as an in-cable control box (ICCB) is known from KR 20190021596 A, by means of which a charged amount of energy at any household socket that is equipped with a smart electricity meter can be billed via a server of the network operator. The first communication unit receives an identity of the outlet where the vehicle is being charged from the smart meter via a wireless data connection. The second communication unit measures the amount of electrical energy charged by means of an electricity meter and sends the measurement data via mobile communications to the network operator's server for billing.

The disadvantage of the currently known billing systems is that an intelligent charging device is required, that is set up to provide a location. However, this is not the case for a significant number of charging devices.

### DESCRIPTION OF THE INVENTION

Based on the known state of the art, the purpose of the present invention is to provide an improved device for documenting the electrical energy used to charge a motor vehicle, as well as a corresponding procedure.

The task is solved by an adapter system with the features of claim 1. Advantageous further developments result from the sub-claims, the description and the figures.

Accordingly, an adapter system is proposed, encompassing a first adapter, which has an electrical energy measuring device for measuring any electrical energy received or emitted by a motor vehicle, a first communication module for a wireless first data connection with a server unit and a second communication module. Furthermore, a second adapter is provided, which has a second communication module for providing a second data connection with the first adapter and an interface which is set up to be connected to a data bus system of the motor vehicle in order to read a vehicle identification number via the data bus system.

In other words, the first adapter of the adapter system can be set up to measure electrical energy received by the motor vehicle from a charging device or supplied by the motor vehicle to an electrical network via the charging device by means of the energy measuring device and to send the measured value of the energy measuring device together with an adapter identification number and a vehicle identification number to the server unit by means of the first communication module. The electrical energy can be received by the motor vehicle from the charging device via the charging cable or delivered by the motor vehicle to a power supply system via the charging cable and the charging device. The motor vehicle can be identified by means of the vehicle identification number and the adapter identification number by the server unit.

For this purpose, the first adapter can be arranged between the charging device and the motor vehicle and/or in the motor vehicle, preferably at a charging current connection of the motor vehicle. For example, the first adapter can be designed as an in-cable-control-box (ICCB). In addition or alternatively, the first adapter can be arranged between a charging plug and the charging current connection of the motor vehicle, preferably in the motor vehicle.

In addition, the first adapter can have a closed and/or sealed housing, which can preferably be designed to be tamper-proof. The housing can be arranged in a charging cable or in the motor vehicle. For this purpose, the housing can have at least one plug connection for connecting a charging plug or an electrical input and output for measuring an electrical energy at the charging current connection of the motor vehicle.

The second adapter can have an interface that is connected to a data bus interface of the motor vehicle. The second adapter can be set up to access the data bus system of the motor vehicle and to send and/or receive signals via the data bus system via the interface that is connected to the data bus interface of the motor vehicle. The data bus system may, for example, be a CAN and/or a LIN data bus system. For example, the second adapter may be configured to read the vehicle identification number from a faulty memory of the drive train system of the motor vehicle, to which an OBD connection of the motor vehicle provides access.

The vehicle identification number can be a string, in particular a sequence of numbers and/or letters, to which the motor vehicle can be clearly assigned. For example, the vehicle identification number can be a Vehicle Identification Number (VIN).

Advantageously, the second adapter can be set up to be arranged in the motor vehicle, whereby the second adapter can preferably be designed to be tamper-proof. For example, the second adapter can have a closed and/or sealed housing that is set up to be permanently arranged in a motor vehicle.

The second adapter can also be set up to send the vehicle identification number to the first adapter, preferably by means of a Bluetooth data connection. The second communication module can be a corresponding sending and/or receiving device for the second data connection, in particular for the Bluetooth data connection. The first adapter can also have a second communication module corresponding to the second data connection, preferably for a Bluetooth data connection, in order to receive the vehicle identification number from the second adapter and to store it in a memory, preferably to buffer store it. The memory can be a volatile memory for this purpose, whereas, by contrast, the memory for the adapter identification number of the first adapter can be a read-only memory.

Using the adapter system, it is possible to document the electrical energy supplied by the motor vehicle to the charging device and in particular to an electricity grid to which the charging device is electrically connected, or the electrical energy received by the motor vehicle from the charging device. For this purpose, the first adapter can be set up to measure the electrical energy supplied by the motor vehicle to the power supply system by means of the energy meter and to send the measured value and/or a price statement of the electrical energy measured by the energy meter to the server unit via the first data connection using the first communication module.

In addition, the first adapter can be set up to transmit the measured value and/or the price statement together with a location information of the charging device and/or the motor vehicle by means of the first communication module to the server unit via the first data connection. For this purpose, the first adapter can have a communication interface which is set up to receive the location information from the charging device, for example, via a radio connection and/or via power line communication (PLC). Specifically, the first communication module in the first adapter can comprise the communication interface.

In addition or as an alternative, the second adapter can be set up to read out location information of the motor vehicle, such as from a control unit of a navigation system of the motor vehicle, via the interface and the data bus interface of the motor vehicle, and to transmit it to the first adapter via the second data connection.

In addition, the server unit can be set up to store location information from a permitted charging device together with the vehicle identification number in the database and to output an error message and/or detect misuse and/or send a command to the first adapter via the first data connection which causes the first adapter to electrically disconnect the motor vehicle from the charging device if the location information received via the first data connection differs from the location information stored in the database for the outputting.

The advantage of this is that an amount of energy supplied to or received from the motor vehicle can be measured independently of the charging device and clearly assigned to the motor vehicle and documented. For example, the electrical energy supplied to the company vehicle at different and, in particular, third-party charging devices can be documented for a user of a company vehicle, in which the company, as the registered owner of the company vehicle, reimburses the user for the costs of electrical energy, and a price statement, for example analogous to a credit card invoice, can be automatically created by means of the documentation.

Likewise, a total of charged electrical energy over a life cycle of the motor vehicle can be documented. Furthermore, a price statement for users of car-sharing services can be created for the respective user via an electrical energy supplied to the motor vehicle at different charging devices and in particular by different users. Since the documentation of the electrical energy consumed by the motor vehicle is carried out independently of the respective charging device, the motor vehicle can be charged at all charging stations. In addition, the adapter system can be used to ensure for the company, as the owner of the company vehicle, that only the company vehicle and no other motor vehicle is charged at the company's expense or unauthorizedly discharged. The billing can be automatically generated and provided to the user at regular intervals by the server unit.

Furthermore, this offers the advantage that an electrical energy supplied by the motor vehicle to the power supply system can be measured independently of the charging device and can be clearly assigned to the motor vehicle, for example, for a user to be compensated for the supply of electrical energy to the power supply system. Furthermore, the adapter system can be used to document to which charging devices the electrical energy was supplied. In addition, the location information can be used by the server unit to detect misuse, such as unauthorized or private use of the electrical energy stored in the battery of a company car.

One variant provides for the interface to be an on-board diagnostic connector (OBD connector). In other words, the second adapter can therefore have an OBD connector and thus access a memory of the motor vehicle and the data bus system of the motor vehicle via the onboard diagnostic access of the motor vehicle as a data bus interface in order to read the vehicle identification number. This has the advantage that an existing connection system is used for the second adapter. One variant provides that the second adapter is set up to read out the vehicle identification number from a memory and/or at least one control unit of the motor vehicle via the data bus system. In other words, the second adapter can be set up to read out the vehicle identification number from a control unit of the motor vehicle, such as a control unit of the drive train, in particular, for example, an engine control unit.

In addition or as an alternative, the second adapter can be set up to access a specific control unit of the motor vehicle to read the vehicle identification number, such as a control unit for a heater or a sunroof. When the second adapter is inserted into an OBD port of another motor vehicle that does not have the specific control unit, the second adapter can be set up to issue an error message and/or detect an attempt at tampering.

In addition or as an alternative, the second adapter can be set up to read the vehicle identification number from several control units of the motor vehicle and to check the read vehicle identification numbers for matches. If there is no match, the second adapter can be set up to detect a manipulation attempt and/or to output an error message.

One variant provides that the second data connection is provided via a wireless personal area network (WPAN), preferably via Bluetooth, and/or wired via the charging cable and a charging current connection of the motor vehicle. In other words, the second communication module can be a wireless personal area network transceiver. The wireless personal area network can be provided by means of Bluetooth or Zigbee, for example, and can connect the second adapter to the first adapter for wireless communication.

In addition or as an alternative, the second data connection can be provided via the charging cable, with the first adapter being set up to communicate with a charging control unit of the motor vehicle by means of the second communication module via a power line communication data connection (PLC data connection) and/or a wired data connection and to read the vehicle identification number. In addition, the second adapter can be set up to send an enable signal to the charging control unit via the data bus system after checking the identity of the vehicle identification number. The first adapter can be set up to read the enable signal from the charging control unit via the power line communication data connection and/or the wired data connection. This has the advantage that the first and second adapters do not have to be connected directly with a cable, which makes the adapter system easier to use in everyday life.

One variant provides for the first data connection to be provided via a mobile network and/or an Internet of Things radio network and/or a local radio network. In other words, the first communication module can be a transceiver for a mobile network and/or for an Internet of Things radio network and/or for a local radio network. The mobile network may, for example, be a 5G network or a Long Term Evolution (LTE) network. This has the advantage of wide-area network coverage for providing the first data connection in the area, but is disadvantageous inside buildings, especially in underground car parks. Using mobile communications, the first data connection can be provided on the road in the area, for example when charging at a motorway.

In addition or as an alternative, the first data connection can be provided via an Internet-of-Things radio network, such as a narrowband Internet-of-Things network (NB-IoT) or an LTE-M network set up for machine communication or a Low Power Wide Area Network (LPWAN), which is used, for example, by Helium® for providing an Internet of Things. By using an Internet-of-Things radio network, better network coverage can be achieved in buildings compared to mobile communications. This can be advantageous, for example, when charging in an underground parking garage where mobile phone reception and/or a local radio network are inadequate.

In addition or as an alternative, the first data connection can also be provided via a local radio network, in particular a wireless LAN radio network (WLAN). The local wireless network can be provided by a radio module of a local hotspot, such as a WLAN router, and/or a radio module of a mobile terminal and/or a radio module of a motor vehicle that is connected to a hotspot to an Internet service provider in the motor vehicle to establish a data connection with the server unit. The mobile terminal may, for example, be a mobile WLAN router or a cell phone that is set up to provide a hotspot to an Internet service provider in the motor vehicle for establishing a data connection with the server unit.

In addition or as an alternative, the first data connection can be provided via a wireless personal area network (WPAN), preferably via Bluetooth, whereby the first communication module in the first adapter can be set up to establish the first data connection via the wide personal area network (WPAN), preferably via Bluetooth, with a further first communication module of a mobile terminal and/or a further first communication module in a motor vehicle. For this purpose, the mobile terminal may be a cell phone that is set up to provide a hotspot to an Internet service provider for establishing a data connection with the server unit. The first communication module in the first adapter and in the motor vehicle can, for example, be a WPAN radio module, such as a Bluetooth radio module, wherein the first communication module in the motor vehicle is connected to a hotspot to an Internet service provider for establishing a data connection with the server unit.

In particular, the first communication module can be designed for a combination of mobile radio and/or an Internet-of-Things radio network and/or a local radio network. Thus, the first adapter can provide the first data connection to the server unit via the first communication module using several redundant options. This is advantageous, for example, if the motor vehicle is charging in an external underground car park where there is no access to a local wireless network and/or reception with mobile communications is insufficient. In this case, for example, the Internet-of-Things wireless network, which can ensure good reception inside buildings, could provide the first data connection. This has the overall advantage that the first data connection to the server unit can be provided at different locations where the vehicle is charging.

In addition, the first adapter can have a memory and be set up to store the energy meter's measurement in the memory. In particular, the first adapter can be set up to store the energy meter's measurement in the memory if the first data connection to the server unit cannot be established by the first adapter. This may be the case, for example, when the motor vehicle is connected to a charging device in an external underground parking garage without network coverage. The measured value can, for example, be stored in the memory for a fixed period of time and/or until the first data connection to the server unit is established by the first adapter. The memory can, for example, be a volatile memory. In addition, the first adapter can be set up to delete the measured value from the memory after it has been transferred to the server unit via the first data connection.

In this way, the electrical energy supplied by the charging device to the motor vehicle or received by the charging device from the motor vehicle can still be documented by means of the first adapter if the first data connection to the server unit cannot be established by the first adapter.

One variant provides that the second communication module is set up to send and/or receive the vehicle identification number by means of the second data connection, whereby preferably the second communication module of the second adapter is set up, on the one hand, to send the vehicle identification number and, on the other hand, the second communication module of the first adapter is set up to receive the vehicle identification number. In other words, the first and second adapters are communicatively connected to one another by means of the second communication module by means of a wireless personal area network. In particular, the first and second adapters can also be communicatively connected to one another by means of the wireless personal area network at locations without mobile radio and/or without local radio network coverage. This has the advantage that the second data connection can be provided independently of network coverage of the charging device, such as coverage with a mobile radio network and/or a local radio network.

Preferably, the second communication module of the first adapter can be set up to establish only one data connection with the second communication module of the second adapter. This has the advantage that the first adapter cannot receive the vehicle identification number from a third transmitter, which increases tamper resistance. The advantage of this is that the second adapter can be designed in a compact way since it only includes a second communication module for a wireless personal area network.

One variant provides that the first adapter is set up to send an adapter identification number together with the vehicle identification number via the first data connection to the server unit by means of the first communication module. In other words, the first adapter can be set up to link the vehicle identification number and the adapter identification number and send them to the server unit. In particular, the motor vehicle can be uniquely assigned in a database of the server unit by means of the adapter identification number and the vehicle identification number.

Thus, in addition, the first adapter can be set up not to send the vehicle identification number and the adapter identification number if the vehicle identification number stored in the buffer of the first adapter and received does not match the vehicle identification number associated with the adapter identification number. For this purpose, the vehicle identification number associated with the adapter identification number may be stored in a read-only memory of the first adapter for verification.

One variant provides for the first adapter to be arranged in a charging cable, in particular the charging cable of a charging device. In other words, the charging cable can be an external charging cable with respect to the charging device, which belongs to the motor vehicle. Alternatively, the first adapter can also be arranged in a cable that is permanently attached to the charging device. This has the advantage that the adapter system can be used independently of a charging device. Furthermore, existing charging devices can be retrofitted with the said adapter system by replacing the charging cable. This can be advantageous, for example, for company-owned charging stations for company cars.

One variant provides that the first adapter is set up to read the vehicle identification number via the charging cable and in particular via an on-board charging control unit of the motor vehicle by means of the second communication module. In other words, the first adapter can be set up to communicate with the charging control unit of the motor vehicle via the charging cable by means of a wired second data connection, in particular by means of power line communication.

In addition, the first adapter can be set up to compare the vehicle identification number read by the vehicle's charging control unit with the vehicle identification number received from the second adapter. If the two vehicle identification numbers differ, the first adapter can be set up to issue an error message and/or indicate an attempt at manipulation.

This has the advantage that the vehicle identification number is read redundantly and thus the adapter system can be designed to be tamper-proof.

One variant provides for the first adapter to be designed as a transfer interface between the charging device and the motor vehicle and is set up to be supplied with electrical energy via the charging cable. In other words, the first adapter can be arranged on a charging plug of the charging cable facing the motor vehicle, at which the electrical energy is transferred from the charging device to the motor vehicle. Alternatively, the first adapter can be arranged between the charging plug and the motor vehicle independently of the charging cable. In addition, the first adapter can be set up to measure only the electrical energy charged by the motor vehicle without power loss by means of the energy measuring device. This has the advantage that the first adapter, in order to comply with legal requirements, does not measure any power loss that would be charged to a user of the motor vehicle.

The invention also provides a motor vehicle with the features of claim 11, comprising a second adapter of said adapter system for measuring a charging current from a charging device, wherein the second adapter is particularly designed as a control unit of the motor vehicle. In other words, instead of being a portable terminal, the second adapter can be designed as a control unit arranged in the motor vehicle, which is connected to the data bus system of the motor vehicle via the interface in order to read out the vehicle identification number. This has the advantage that the second adapter cannot be forgotten by a user, which improves the quality of the data documentation. In addition, this can make it more difficult for a third party to manipulate.

One variant provides for the second adapter to be arranged in the motor vehicle in a tamper-proof manner. More specifically, the control unit can be arranged in an engine compartment of the motor vehicle. This has the advantage that the quality of the data documentation can be further improved.

In addition, the motor vehicle can comprise the first adapter, wherein the first adapter in the motor vehicle is electrically connected to a charging current connection of the motor vehicle. Preferably, the first adapter can be arranged in the motor vehicle at the charging current connection.

The motor vehicle is preferably designed as a motor vehicle, in particular as a passenger car or a truck, or as a passenger bus or motorcycle. The motor vehicle can be electrically powered (EV) or, in particular, a hybrid electric vehicle (HEV, PHEV).

The above task is further solved by a measuring method for a motor vehicle with the features of the claim for supplying or receiving electrical energy. Advantageous further variants of the procedure arise from the subclaims as well as the present description and figures.

Accordingly, a measuring method for discharging or receiving electrical energy for a motor vehicle at a charging device by means of said adapter system and a server unit is proposed, which comprises the following steps:
reading a vehicle identification number of the motor vehicle via an interface and a corresponding data bus interface to a data bus system of the motor vehicle by means of a second adapter of the adapter system,
transmitting the vehicle identification number by means of a second communication module of the second adapter via a second data connection to a first adapter of the adapter system,
storing the vehicle identification number in a memory of the first adapter,
transmitting an adapter identification number of the first adapter together with the vehicle identification number by means of a first communication module of the first adapter via a first data connection to the server unit,
comparison by the server unit of the transmitted adapter identification number and the vehicle identification number with an adapter identification number and a vehicle identification number stored in a database of the server unit,
transmission of a release signal by the server unit to the first adapter by way of the first communication module via the first data connection to start a transmission process of electrical energy if the transmitted adapter identification number and vehicle identification number match the adapter identification number and vehicle identification number stored in the database.

In other words, the transmission process can involve the motor vehicle absorbing electrical energy from the charging device and/or the motor vehicle feeding electrical energy into the grid via the charging device. The second adapter can read the vehicle identification number from a memory and/or at least one control unit of the motor vehicle, compare them with each other and only send the vehicle identification number to the first adapter if they match. The vehicle identification number received by the first adapter via the second communication module can be stored in a volatile memory of the first adapter for this purpose.

The first adapter can additionally compare the received vehicle identification number with a vehicle identification number assigned to the adapter identification number, which is stored, for example, in a read-only memory, and only if there is a match does it transmit the adapter identification number and the received vehicle identification number to the server unit by means of the first communication module.

The motor vehicle can be clearly assigned to the adapter identification number and the vehicle identification number in the database for identification. The server unit can verify the received adapter identification number and the vehicle identification number and, if the verification is successful, transmit the release signal to the first adapter by means of the first communication module via the first data connection to start the transmission process.

As an alternative to transmitting the release signal to the first adapter, a transmission process can still be started by the first adapter if the verification is unsuccessful, in which case the first adapter does not send any measurement data to the server unit, so that the electrical energy consumed is not recorded in the price statement in the database, so that, for example, a user has to pay for the electrical energy consumed themselves. This has the advantage that the energy quantities charged to the motor vehicle over time and at different charging stations can be clearly assigned to the motor vehicle and documented.

One variant provides that the procedure also includes the following step:
measuring electrical energy transmitted via the charging device by means of an energy measuring device of the first adapter and storing a measured value in the memory of the first adapter.
transmitting the measured value, preferably together with the adapter identification number and the vehicle identification number, via the first data connection to the server unit by means of the first communication module of the first adapter,
storing the measured value in the database of the server unit, preferably together with the adapter identification number and the vehicle identification number, in particular incrementing an amount of energy of the respective electrical energy transmitted, which amount is stored in the database together with the adapter identification number and the vehicle identification number,
creating a price statement by means of the energy quantity and/or the measured value stored in the database by the server unit and storing the price statement in the database.

In other words, the electrical energy transmitted can be electrical energy absorbed or emitted by the motor vehicle. The electrical energy is measured by the first adapter and can be sent from the first adapter to the server unit via the first communication module. The adapter identification number and the vehicle identification number can only be verified after sending, whereby the measurement data is only stored in the server unit database after successful verification by the server unit.

Alternatively, the adapter identification number and the vehicle identification number can be sent to the server unit for verification before the electrical energy is transferred, whereby the transfer of electrical energy is only started after successful verification by the server unit of the first adapter. After the end of and/or during the transmission of the electrical energy, the measurement data can be sent from the first adapter to the server unit. In addition, the amount of electrical energy consumed can be added up by the server unit with the amount of electrical energy supplied. This has the advantage that the price statement with respect to the motor vehicle can be created independently of the charging device. In this case, the price statement for an amount of energy consumed can be a cost calculation, whereas the price statement for an amount of energy supplied can be a reimbursement. The server unit can also offset the cost calculation for the energy consumed against the reimbursement for the energy supplied with respect to the motor vehicle.

One variant provides that the method also includes the step of:
Provision of the measurement value and/or the amount of energy and/or the price statement to a user's end device via the first data connection by the server unit, in particular to the end device of a registered user stored in the database together with the adapter identification number and vehicle identification number.

In other words, in the case of several users, such as several drivers of a company vehicle or a shared vehicle in a car-sharing service, only the price statement assigned to each user can be provided by the server unit to a terminal. This has the advantage that a price statement can be created and documented for several users of a motor vehicle.

The adapter system, in particular the first and second adapters, and additionally the server unit, can each be provided as an electronic control unit (ECU) for this purpose, which comprises at least one processor and/or at least one memory, program instructions being stored in the memory which cause the at least one processor to execute the said procedure. In other words, the adapter system, in particular the first and second adapters, and additionally the server unit, can each have a data processing device or at least a processor device that is set up to carry out the above-described procedure. For this purpose, the processor device can comprise at least one microprocessor and/or at least one microcontroller and/or at least one FPGA (Field Programmable Gate Array) and/or at least one DSP (Digital Signal Processor). Furthermore, the processor device can have program code that is set up to carry out the variant of the said procedure when executed by the processor device. The program code can be stored in a data memory or processor device.

### BRIEF DESCRIPTION OF THE FIGURES

Further preferred variants of the invention are explained in more detail in the following description of the figures. The following figures are used:

FIG. 1 shows a schematic overview of the adapter system used when charging a motor vehicle to a charging device; and

FIG. 2 shows a schematic overview of the measurement method.

### DETAILED DESCRIPTION OF PREFERRED EXAMPLES OF VARIANTS

In the following, preferred examples of variants are described on the basis of the figures. Identical, similar or equivalent elements in the different figures are provided with identical reference signs, and a repeated description of these elements is partially dispensed with in order to avoid redundancies.

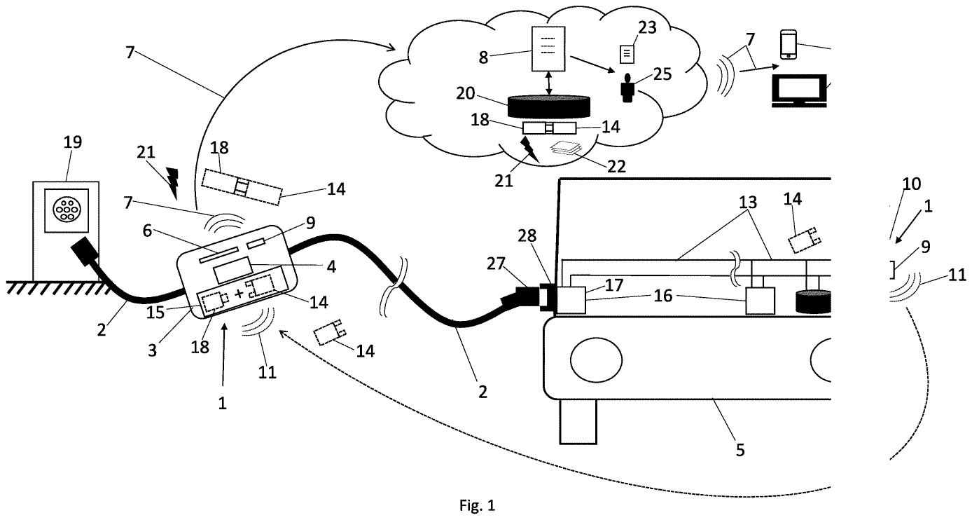

FIG. 1 schematically shows an adapter system 1 that is used when charging a motor vehicle 5 at any charging device 19 by means of the charging cable 2 in order to document in a database 20 of a server unit 8 how much electrical energy has been absorbed by the motor vehicle 5 or delivered to a power grid via the charging device 19. In this way, documentation of the respective charging process can be achieved, even if the respective wallbox is not set up to measure the electrical energy.

The adapter system 1 comprises two adapters 3 and 10, the first adapter 3 being arranged at a transfer interface between the motor vehicle 5 and the charging device 19, such as in the charging cable 2. The first adapter 3 can be designed as an in-cable control box (ICCB). Alternatively, the first adapter 3 can be arranged in the motor vehicle 5, preferably in a charging current connection 28 of the motor vehicle 5.

The second adapter 10, on the other hand, is located on and/or in motor vehicle 5 and has an interface 12 with which the second adapter 10 can be connected to a data bus system 13 of motor vehicle 5 via the data bus interface 26 of the motor vehicle 5. For example, the interface 12 of the second adapter 10 can be an on-board diagnostic plug and the data bus interface 26 can be a socket corresponding to interface 12. The second adapter 10 can, for example, be designed as a mobile terminal.

In addition or as an alternative, the second adapter 10 can also be designed as a control unit 16 in the motor vehicle 5, which is connected to the data bus system 13 via an interface 12 and is preferably arranged in the motor vehicle 5 in a tamper-proof manner. The data bus system 13 in the motor vehicle 5 can, for example, be a CAN or a LIN data bus system 13, with which a plurality of control units 16, in particular a charging control unit 17 of the motor vehicle, are communicatively connected to one another. In addition, memory 15 of the motor vehicle 5 is connected to the data bus system 13. Memory 15 can, for example, be an error memory of a control unit 16 of the drive train system of the motor vehicle 5, such as, for example, the error memory of an engine control unit.

The second adapter 10 is set up to read a vehicle identification number 14 via the data bus system 13 and to send it to the first adapter 3 by means of a second communication module 9 via a second data connection 11. The second adapter 10 can, for example, be set up to read vehicle identification number 14 from the memory 15 or from one or more control units 16. The vehicle identification number 14 can, for example, be a vehicle identification number (VIN) or another identification number which is present, for example, in the fault memory of a control unit 16 of the drive train, for example the engine control unit.

In addition or as an alternative, the second adapter 10 can be set up to read the vehicle identification number 14 from a control unit 16, such as a charging control unit 17 or a heating control unit or in particular a sunroof control unit, and to check the individual vehicle identification numbers 14 from the respective control devices for correspondence and to output an enabling signal via the second data connection and/or via the second data bus system 13, in order to be able to identify the motor vehicle 5 unambiguously and in a tamper-proof manner. For example, the second adapter 10 can read out the vehicle identification number from a specific control unit 16 via the data bus system 13, which specifically includes the motor vehicle 5, such as a heating or sunroof control unit. If the said control unit 16 cannot be addressed during the reading process, for example because it is not present in another motor vehicle 5, the second adapter 10 can be set up to output an error message and/or to detect a manipulation attempt.

In addition or as an alternative, the second adapter 10 can be set up to read the vehicle identification number 14 from several control units 16 and to check the respective vehicle identification numbers 14 from the respective control units 16 for a match. If there is no match, the second adapter 10 can be set up to output an error message and/or to recognize an attempt at manipulation. If the respective vehicle identification numbers 14 match, the second adapter 10 can be set up to confirm that it is the specific motor vehicle 5 and to send the vehicle identification number 14 to the first adapter 3 by means of the second communication module 9 via the second data connection 11. For this purpose, the second data connection 11 can be provided as a wireless data connection. For example, the second data connection 11 can be provided via a wireless personal area network (WPAN), such as a Bluetooth data connection.

In addition or as an alternative, the first adapter 3 can be set up to read the vehicle identification number 14 from the charging control unit 17, such as an on-board charger control unit, by means of the second communication module 9 via a wired second data connection 11 via the charging cable 2, which is connected to the charging plug 27 to the charging current connection 28 of the motor vehicle 5. In addition, the first adapter 3 can be set up to read out a release signal of the second adapter 10, which the second adapter 10 has stored in the charging control unit 17 via the data bus system 13, via the wired second data connection 11. In this case, the second wire-based data connection 11 can be provided, for example, by means of power line communication (PLC). More particularly, the first adapter 10 can be set up to read the release signal of the first adapter 10, which was output to the charging control unit 17 via the data bus system 13 after the vehicle identification number 14 was checked, from the charging control unit 17 by means of the second communication module 9.

Alternatively, the charging current connection 28 can have a data bus interface for the power line communication with the second communication module 9 of the first adapter 3 via the charging cable 2.

The first adapter 3 can, for example, be arranged in the charging cable 2 and set up to measure, by means of the energy measuring device 4, an electrical energy charged by the motor vehicle 5 via the charging device 19.

Alternatively, the first adapter 3 can also be connected between the charging plug 27 and the motor vehicle 5. The first adapter 3 can also be set up to be supplied with electrical energy via the charging cable 2 by means of a branch. The first adapter 3 has its own adapter identification number 18 and is set up to store the vehicle identification number 14 in an internal memory 15 and to send the vehicle identification number 14 together with the adapter identification number 18 to the server unit 8 via a first data connection 7 by means of a first communication module 6. For this purpose, the adapter identification number 18 can be stored in a read-only memory of the first adapter 3, while the vehicle identification number 14 received by means of the second communication module 9 can be stored in a volatile memory. The first adapter 3 can comprise a read-only memory 15 and a volatile memory 15 for this purpose.

The first data connection 7 can be provided via a mobile network, in particular via a 5G network, a Long Term Evolution (LTE) network. In addition or alternatively, the first data connection 7 can be provided via an Internet of Things radio network, such as a Narrow Band Internet of Things (NB-IoT) network or a LTE-M network set up for machine communication or a low-energy wide area network (LPWAN), which is used for example by Helium® for the Internet of Things. By using an Internet of Things radio network, better network coverage can be achieved in buildings compared to mobile communications.

In addition or as an alternative, the first data connection 7 can also be provided via a local radio network, in particular a wireless LAN radio network (WLAN), and/or via a wireless personal area network (WPAN) of a hotspot for Internet access. The hotspot to an Internet service provider can be provided by a mobile terminal 24 and/or by the motor vehicle 5 and/or by a local WLAN router. In particular, the first communication module 6 can be designed for a combination of mobile radio and/or an Internet-of-Things radio network and/or a local radio network. Thus, the first adapter 3 can establish the first data connection 7 to the server unit 8 via a plurality of redundant options by means of the first communication module 6. This is advantageous, for example, if the motor vehicle 5 is charging in an external underground car park where access to a local wireless network and/or network coverage with mobile communications is problematic. In this case, for example, the Internet of Things wireless network, which can ensure good reception within buildings, could provide the first data connection 7.

The first adapter 3 is set up to measure the electrical energy charged by the motor vehicle 5 by means of the energy measuring device 4 and to send the measured value 21 together with the adapter identification number 18 and the vehicle identification number 14 by means of the first communication module 6 via the first data connection 7 to the server unit 8.

The server unit 8 can also have the first communication module 6 and/or be set up to receive the data sent via the first data connection 7. The server unit 8 is set up to receive the measured value 21 via the charged electrical energy together with the adapter identification number 18 and the vehicle identification number 14 and to compare the received adapter identification number 18 and vehicle identification number 14 with the adapter identification number 18 and vehicle identification number 14 stored in a database 20. If the adapter identification number 18 and vehicle identification number 14 sent match the adapter identification number 18 and vehicle identification number 14 stored in the database 20, server unit 8 identifies the motor vehicle 5 unambiguously and stores the measured value 21 in the database 20 and/or increments a value, stored in the database 20, of an amount of energy 22 that has already been consumed or delivered. The amount of energy 22 designates the sum of the measured values 21 of the electrical energies that have already been consumed or delivered. The measured value 21 and the quantity of energy 22 are assigned to the adapter identification number 18 and the vehicle identification number 14 in the database 20. This makes it possible, for example, to document a record of the electrical energy absorbed or delivered by the motor vehicle 5 at various charging devices 1, in particular over time. For example, users 25 of company vehicles can keep a record of the electrical energy received or discharged at different charging devices 1, such as a private house connection or a third-party quick charging station; the measured values 21 and/or the amount of energy 22 are stored in the database 20 of the server unit 8 and can be accessed by the company and/or by the user by means of a terminal 7. The user 25 can therefore be an employee of the company to whom the motor vehicle 5 is provided as a company car and/or the company can be the user 25, such as a personnel dispatcher. For example, user 25 can be further subdivided into a user 25 with administrator rights, in particular a user 25 with read and write permission for database 20, and a user 25 with usage rights, in particular read permission for database 20. User 20 with administrator rights can also create multiple users 25 with usage rights. This means, for example, that several simultaneous users 25 of a company car can be managed.

The server unit 8 can also be set up to create price statement 23 with respect to the measurement 21 stored in the database 20 and/or with respect to the amount of energy 22, for example as the sum of the previous measurements 21. The price statement 23 and/or the measured value 21 and/or the amount of energy 22 are uniquely assigned in the database 20 to the adapter identification number 18 and the vehicle identification number 14, so that the electrical energy received from or supplied to different charging devices 1 can be clearly documented with respect to the motor vehicle 5. For example, the price statement 23 for an amount of energy 22 that has been received can be a cost calculation, whereas the price statement for an amount of energy 22 that has been delivered can be a reimbursement. Furthermore, the costs for the amount of energy 22 that has been received and the amount of energy 22 that has been delivered can be offset against each other by server unit 8 for the price statement 23.

In addition, the price statement 23 and/or the measured value 21 and/or the amount of energy 22 can be assigned to the respective user 25 in the database, so that the server unit 8 can be set up, for example, to create a separate price statement 23 for several users 25 of the motor vehicle 5. The server unit 8 and the database 20 together form a cloud infrastructure, which provides said data via the first data connection 7 to a user terminal 24, such as a mobile terminal like a smartphone or a stationary terminal like a personal computer (PC).

In addition, the server unit 8 can be set up to provide said data only to a terminal device 24 that is registered with respect to the user 25. This can also improve data security.

The adapter system 1 described above can also be used in a car-sharing service, in which the adapter system 1 and in particular the second adapter 10 are digitally linked to the motor vehicle 5 by the server unit 8 by matching the adapter identification number 18 of the first adapter 3 and the vehicle identification number 14 read from the second adapter 10 with an adapter identification number 18 and vehicle identification number 14 stored in the database 20. Furthermore, in a car-sharing service, the second adapter 10 can be designed to verify the vehicle identification number 14 before sending it to the first adapter 3 and/or can itself be designed as a control unit 16 that is arranged in the motor vehicle 5 in a tamper-proof manner.

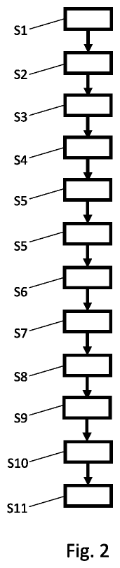

FIG. 2 shows a schematic application of the adapter system 1 when a motor vehicle 5 is charging at charging device 19, wherein the motor vehicle can at least partially absorb and/or release electrical energy during charging. In first step S1, the vehicle identification number 14 of the motor vehicle 5 is read out via an interface 12 of the second adapter 10 and a corresponding data bus interface 26 to a data bus system 13 of the motor vehicle 5 by means of the second adapter 10 of the adapter system 1. For this purpose, the second adapter 10 can, for example, have a plug for an on-board diagnostic connection of the motor vehicle 5.

In second step S2, the vehicle identification number 14 is transmitted by means of a second communication module 9 of the second adapter 10 via a second data connection 11 to a first adapter 3 of the adapter system 1. The second adapter 10 can, for example, send the vehicle identification number 14 to the first adapter 3 by means of a Bluetooth data connection. The second communication module 9 in the first 3 and second adapters 10 can be a corresponding transmitting and/or receiving device.

In third step S3, the vehicle identification number 14 is stored in memory 15 of the first adapter 3, preferably buffered for further transmission.

In fourth step S4, the adapter identification number 18 of the first adapter 3 is transmitted together with the vehicle identification number 14 by means of the first communication module 6 of the first adapter 3 via a first data connection 7 to the server unit 8. The adapter identification number 18 can also be stored in memory 15 or preferably in a read-only memory of the first adapter 3.

In fifth step S5, the transmitted adapter identification number 18 and the vehicle identification number 14 are compared by the server unit 8 with an adapter identification number 18 and a vehicle identification number 14 stored in a database 20 of the server unit 8.

In sixth step S6, a release signal can then be transmitted by the server unit 8 to the first adapter 3 by means of the first communication module 6 via the first data connection 7 to start a transmission process of electrical energy, when the adapter identification number 18 and the vehicle identification number 14 transmitted match the adapter identification number 18 and the vehicle identification number 14 stored in the database 20. The transmission process can include the receiving and/or the delivery of electrical energy by the motor vehicle.

Alternatively, in the sixth step S6, electrical energy can still be transmitted, whereby the first adapter 3 is set up not to send any measurement data 21 to the server unit 8 if the transmitted adapter identification number 18 and vehicle identification number 14 do not match the adapter identification number 18 and vehicle identification number 14 stored in the database 20, so that the electrical energy consumed is not recorded in the price statement 23 in the database 20. This can, for example, force a user to pay for the electrical energy consumed themselves.

In seventh step S7, if the adapter identification number 18 and vehicle identification number 14 sent match the adapter identification number 18 and vehicle identification number 14, the electrical energy received or delivered via the charging device 19 is measured by means of an energy measuring device 4 of the first adapter 3 and a measured value 21 is stored in the memory 15 of the first adapter 3.

In eighth step S8, the measured value 21 is preferably transmitted together with the adapter identification number 18 and the vehicle identification number 14 by means of the first communication module 6 of the first adapter 3 via the first data connection 7 to the server unit 8.

For this purpose, the first communication module 6 can transmit the said data via mobile radio and/or an Internet of Things radio network and/or via a local radio network depending on current availability, for example when charging at home or at a fast charging station on the highway or in an unknown underground parking garage.

In ninth step S9, the measured value 21 is stored in the database 20 of the server unit 8, preferably together with the adapter identification number 18 and the vehicle identification number 14. In addition, an amount of energy 22 for the electrical energy consumed or supplied is incremented in each case together with the adapter identification number 18 and the vehicle identification number 14 stored in the database 20. The amount of energy 22 can thus be a sum of the individual measured values 21 over time. In this way, a quantity of electrical energy that is clearly assigned to the motor vehicle 5 is stored in database 20. In addition, the energy quantities 22 consumed or delivered can be offset against each other in the server unit 8.

In tenth step S10, a price statement 23 is created by the server unit 8 using the amount of energy 22 stored in the database 20 and/or the measured value 21, and the price statement 23 is stored in the database 20. Price statement 23 can thus be a record of the electrical energy received from or supplied to various charging devices 19 by the motor vehicle 5 over time and can be a basis for billing a user 25, such as a driver of a company vehicle. The documentation created by the server unit 8 in this way can thus be set up like a credit card statement.

In eleventh step S11, measurement 21 and/or the amount of energy 22 and/or the price statement 23 are provided to a terminal 24 of the user 25 via the first data connection 7 by the server unit 8. In addition, measurement 21 and/or the energy quantity 22 and/or the price statement 23 are provided to the terminal 24 of a registered user 25 stored in the database 20 together with the adapter identification number 18 and vehicle identification number 14. For example, there may be several users 25, for example several drivers of a company vehicle, whereby only the price statement 23 assigned to him can be provided to each user 25.

Insofar as applicable, all the individual features presented in the examples of variants can be combined and/or exchanged without leaving the scope of the invention.

### LIST OF REFERENCE NUMBERS

1 Adapter system
2 Charging cable
3 First adapter
4 Energy measuring device
5 Motor vehicle
6 First communication module
7 First data connection
8 Server unit
9 Second communication module
10 Second adapter
11 Second data connection
12 Interface
13 Data bus system
14 Vehicle identification number
15 Memory
16 Control unit
17 Charging control unit
18 Adapter identification number
19 Charging device
20 Database
21 Measured value
22 Energy quantity
23 Price statement
24 Terminal
25 User
26 Data bus interface
27 Charging plug
28 Charging current connection
S1 First step
S2 Second step
S3 Third step
S4 Fourth step
S5 Fifth step
S6 Sixth step
S7 Seventh step
S8 Eighth step
S9 Ninth step
S10 Tenth step
S11 Eleventh step

1. An adapter system comprising a first adapter which has an electrical energy measuring device for measuring an electrical energy absorbed or emitted by a motor vehicle a first communication module for a wireless first data connection with a server unit and a second communication module a second adapter has the second communication module for providing a second data connection to the first adapter and an interface which is set up to be connected to a data bus system of the motor vehicle in order to read out a vehicle identification number via the data bus system

2. The adapter system according to claim 1, wherein the interface is an on-board diagnostic plug.

3. The adapter system according to claim 2, wherein the second adapter is set up to read out the vehicle identification number from at least one of: a memory and at least one control unit of the motor vehicle via the data bus system by means of the interface

4. The adapter system according to claim 3, wherein the second data connection is provided via at least one of: a wireless personal area network (WPAN), and in a wired fashion via the charging cable and a charging-current connection of the motor vehicle

5. The adapter system according to claim 4, wherein the first data connection is provided via at least one of: a mobile radio network, an Internet of Things radio network, and/or local radio network.

6. The adapter system according to claim 5, wherein the second communication module is set up to at least one of: send and receive the vehicle identification number by means of the second data connection wherein the second communication module of the second adapter is configured to at least one of: send the vehicle identification number and, receive the vehicle identification number.

7. The adapter system according to claim 6, wherein the first adapter is set up to send an adapter identification number together with the vehicle identification number to the server unit via the first data connection by means of the first communication module

8. The adapter system according to claim 7, wherein the first adapter is arranged in a charging cable of a charging device.

9. The adapter system according to claim 8, wherein the first adapter is set up to read out the vehicle identification number by means of the second communication module via the charging cable and via an on-board charging control unit of the motor vehicle.

10. The adapter system according to claim 9, wherein that the first adapter is designed as a transfer interface between the charging device and the motor vehicle and is set up in particular to be supplied with electrical energy via the charging cable

11. A motor vehicle comprising a second adapter of an adapter system for measuring a charging current from a charging device, the second adapter being in the form of a control unit of the motor vehicle

12. The motor vehicle according to claim 11, wherein the second adapter is arranged in the motor vehicle in a tamper-proof manner.

13. A measuring method for at least one of: supplying and receiving electrical energy for a motor vehicle at a charging device by means of an adapter system and a server unit comprising the following steps:
reading a vehicle identification number of the motor vehicle via an interface and a corresponding data bus interface to a data bus system of the motor vehicle by means of a second adapter of the adapter system;
transmission of the vehicle identification number by means of a second communication module of the second adapter via a second data connection to a first adapter of the adapter system;
storing the vehicle identification number in a memory of the first adapter;
transmission of an adapter identification number of the first adapter together with the vehicle identification number by means of a first communication module of the first adapter via a first data connection to the server unit;
comparison by the server unit of the adapter identification number sent and the vehicle identification number with an adapter identification number and a vehicle identification number stored in a database of the server unit;
transmission of a release signal by the server unit to the first adapter by means of the first communication module via the first data connection to start a transmission process of electrical energy, if the transmitted adapter identification number and vehicle identification number match the adapter identification number and vehicle identification number stored in the database;
reading a vehicle identification number of the motor vehicle via an interface and a corresponding data bus interface to a data bus system of the motor vehicle by means of a second adapter of the adapter system;
transmission of the vehicle identification number by means of a second communication module of the second adapter via a second data connection to a first adapter of the adapter system;
storing the vehicle identification number in a memory of the first adapter;
transmission of an adapter identification number of the first adapter together with the vehicle identification number by means of a first communication module of the first adapter via a first data connection to the server unit;
comparison by the server unit of the adapter identification number sent and the vehicle identification number with an adapter identification number and a vehicle identification number stored in a database of the server unit; and
transmission of a release signal by the server unit to the first adapter by means of the first communication module via the first data connection to start a transmission process of electrical energy, if the transmitted adapter identification number and vehicle identification number match the adapter identification number and vehicle identification number stored in the database

14. The measuring method according to claim 13, further comprising the steps of:
measurement of electrical energy transmitted via the charging device by means of an energy measuring device of the first adapter and storage of a measured value in the memory of the first adapter,
transmission of the measurement value together with the adapter identification number and the vehicle identification number, by means of the first communication module of the first adapter via the first data connection to the server unit;
storage of the measurement value in the database of the server unit, together with the adapter identification number and the vehicle identification number, incrementing an amount of energy of the respective electrical energy transmitted, which amount is stored in the database together with the adapter identification number and the vehicle identification number;
storage of the measured value in the database of the server unit together with the adapter identification number and the vehicle identification number, incrementing an amount of energy of the respective electrical energy transferred, which amount is stored in the database together with the adapter identification number and the vehicle identification number; and
creation of a price statement by means of at least one of the energy quantity and the measured value stored in the database by the server unit and storage of the price statement in the database.

15. The measuring method according to claim 14, further comprising the step of:
provision of at least one of: the measurement, the amount of energy, and the price statement to a terminal of a user via the first data connection by the server unit, to the terminal device of a registered user stored in the database together with the adapter identification number and vehicle identification number.
